(19) United States
(12) Patent Application Publication
(10) Pub. No.: US 2022/0118465 A1
(43) Pub. Date: Apr. 21, 2022

(54) SPRAY NOZZLE WITH POSTERIOR POSITIONED SWITCH

(71) Applicant: QING YI METAL PRODUCTS ENTERPRISE CO., LTD., Zhongshan.Guangdong (CN)

(72) Inventors: Kaishan ZHANG, Zhongshan, Guangdong (CN); Shulong LI, Zhongshan, Guangdong (CN); Zhenzhen SONG, Zhongshan, Guangdong (CN); Tangjie YOU, Zhongshan, Guangdong (CN)

(21) Appl. No.: 17/419,517

(22) PCT Filed: Mar. 19, 2021
(86) PCT No.: PCT/CN2021/081835

§ 371 Date: Jun. 29, 2021

(30) Foreign Application Priority Data
Aug. 4, 2020 (CN) 202021598510.0

(51) Int. Cl. B05B 1/34; B05B 9/08

(52) U.S. Cl. CPC B05B 1/3402; B05B 9/08

(57) ABSTRACT

A spray nozzle with posterior positioned switch includes a body (1), a shaft (2) and a pressing bar (3). The body (1) includes a plug (4) blocking off an inner channel. The plug (4) has a through hole (41) in communication with the inner channel. The pressing bar (3) is hinged on a posterior of the body (1). The shaft (2) extends outside the body (1) and is connected to the pressing bar (3). The body (1) includes a first compression spring (5) to push the shaft (2) forward to block off the through hole (41). A positioning mechanism is disposed between the body (1) and the pressing bar (3). The positioning mechanism is controlled by fingers except for thumb to stop the depressed pressing bar (3) in a case that a handle (11) of the body (1) is held in hand.

### FIELD OF THE INVENTION

The present invention relates to a spray nozzle with posterior positioned switch.

### BACKGROUND OF THE INVENTION

A conventional spray nozzle includes a body with a plug having a through hole. A middle portion of a pressing bar is hinged on a posterior of the body. An upper end of the pressing bar is connected with a shaft which is capable of sealing the through hole. The shaft is normally pushed forward by a compression spring to seal the through hole for stopping water. To eject water, pressing a lower end of the pressing bar to pull the shaft backward so that the through hole is opened.

User, when using the spray nozzle, holds the body with one hand and presses upon the pressing bar to eject water. A hook disposed between the pressing bar and the body may hook the pressing bar for positioning. Based on this positioning action being usually completed by the other hand, it is very inconvenient if there is something on the hand. Besides, it costs a certain strength for the fingers to hold the body, and thus it will cost much more strength for the thumb to operate the hook at the meanwhile.

### SUMMARY OF THE INVENTION

The primary object of the present invention is to provide a spray nozzle that has a simple structure to achieve a convenient and labor-saving operation.

In order to achieve the above object, a spray nozzle with posterior positioned switch includes a body, a shaft and a pressing bar. The body includes a plug blocking off an inner channel disposed in the body. The plug is provided with a through hole in communication with the inner channel. A middle portion of the pressing bar is hinged on a posterior of the body. A rear end of the shaft extends outside the body and is connected to an upper end of the pressing bar. A front end of the shaft is provided with a sealing portion capable of blocking off the through hole. The body is provided with a first compression spring to push the shaft forward for the sealing portion blocking off the through hole. A positioning mechanism is disposed between the body and the pressing bar. The positioning mechanism is controlled by fingers except for thumb to stop the depressed pressing bar in a case that a handle of the body is held in hand.

In an embodiment, the positioning mechanism includes a positioning rod capable of moving back and forth on the body. A rear end of the positioning rod is connected with the upper end of the pressing bar to be moved back and forth along with a swinging motion of the pressing bar. The handle of the body includes a stopping device that can act at a front end of the positioning rod to stop the depressed pressing bar from rebounding.

Preferably, a front side of the handle includes a recess. The stopping device includes a button, arranged in the recess and rotatably connected with the body, capable of rotating within a certain range of angle. A groove is disposed in the body and communicates with the recess. The positioning rod is moved along the groove to insert into the recess. The button is provided with a stop column that is misaligned with the positioning rod. The stop column is moved to a position in front of the positioning rod after the pressing bar is depressed, so that the positioning rod abuts against the stop column and is stopped from moving forward. The button is matched in the recess and is held as a result of the positioning rod abutting against the stop column.

Preferably, an upper portion of the button is hinged on two side walls of the recess. The stop column locates under the positioning rod. In a case that the positioning rod exits the recess, the button is rotated clockwise by pressing upon a lower portion of the button to raise the stop column for moving to the position in front of the positioning rod. The positioning rod abuts against the stop column and provides a clockwise torque that is performed by the first compression spring after releasing the pressing bar. The button is provided with an inclined wall capable of abutting against a bottom surface of the recess to limit the button from rotating when the stop column is moved to the position in front of the positioning rod.

Preferably, a second compression spring is disposed between the lower portion of the button and the body. The second compression spring pushes the lower portion of the button forward to provide a counterclockwise torque.

Preferably, a slot is disposed in a position above the stop column on the button. The slot is capable of being inserted with the positioning rod to limit the button from rotating.

Preferably, each of the groove and the recess is isolated from the inner channel of the body.

Preferably, the rear end of the positioning rod is rotatably connected with the upper end of the pressing bar.

Preferably, a water inlet is disposed at a bottom end of the handle, and a water outlet is disposed at an anterior of the body.

The present invention has the following advantages:

1. The operation of the spray nozzle can be completed with a single hand. That is, just using fingers except for thumb to stop the depressed pressing bar, water may be ejected continuously. It is so labor-saving as to avoid falling off due to unsteady holding.

2. When in use, press the pressing bar to make the positioning rod exit the slot, and then press the button with forefinger to make the stop column move to the front of the positioning rod. After releasing the pressing bar, the pressing bar rebounds slightly so that the positioning rod moves back to abut against the stop column. Therefore, the pressing bar is fixed after releasing the button, and water is ejected. When to stop water, press the pressing bar to move the positioning rod backward for leaving the stop column, and then the pressing bar rebounds automatically through the second compression spring so that the sealing portion seals the through hole to stop water. In the meanwhile, the positioning rod inserts into the slot to relock the button.

### BRIEF DESCRIPTION OF THE DRAWINGS

FIG. 1 is an exploded view according to the present invention;

FIG. 2 is a cross-sectional view according to the present invention;

FIG. 3 is a perspective view showing the configuration of the positioning rod and the button;

FIG. 4 is a schematic view of the present invention when in use; and

FIG. 5 is a cross-sectional view of the present invention when in use, showing that the positioning rod abuts against the stop column.

### DETAILED DESCRIPTION OF THE PREFERRED EMBODIMENTS

Embodiments of the present invention will now be described, by way of example only, with reference to the accompanying drawings.

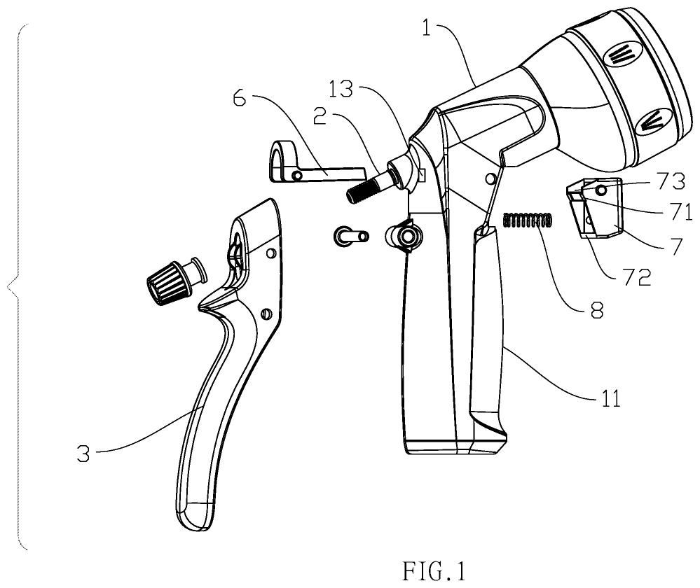

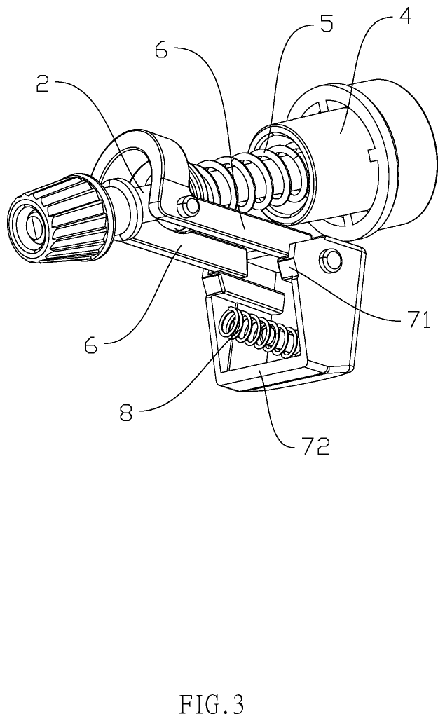

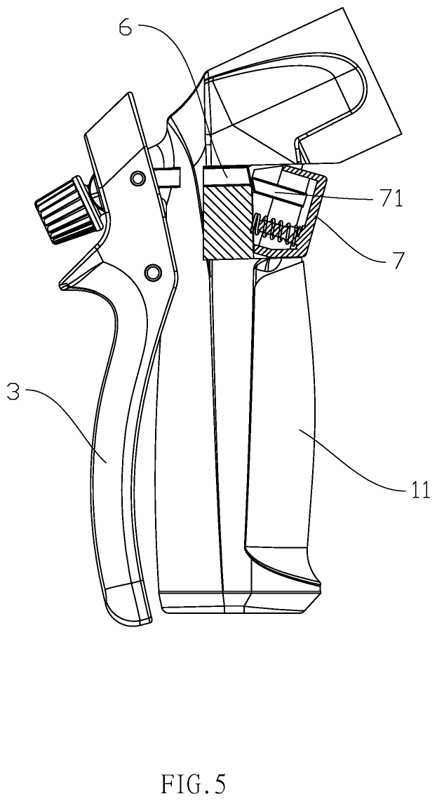

Referring to FIG. 1-5, the present invention discloses a spray nozzle with posterior positioned switch includes a body 1, a shaft 2 and a pressing bar 3. The body includes a plug 4 blocking off an inner channel disposed in the body 1. The plug 4 is provided with a through hole 41 in communication with the inner channel. A middle portion of the pressing bar 3 is hinged on a posterior of the body 1. A rear end of the shaft 2 extends outside the body 1 and is connected to an upper end of the pressing bar 3. A front end of the shaft 2 is provided with a sealing portion 21 capable of blocking off the through hole 41. The body 1 is provided with a first compression spring 5 to push the shaft 2 forward for the sealing portion 21 blocking off the through hole 41. A positioning mechanism is disposed between the body 1 and the pressing bar 3. The positioning mechanism is controlled by fingers except for thumb to stop the depressed pressing bar 3 in a case that a handle of the body is held in hand. The operation of the spray nozzle can be completed with a single hand. It is so labor-saving as to avoid falling off due to unsteady holding.

As shown in FIG. 1-3, the positioning mechanism includes a positioning rod 6 capable of moving back and forth on the body 1. A rear end of the positioning rod 6 is connected with the upper end of the pressing bar 3 to be moved back and forth along with a swinging motion of the pressing bar 3. The handle 11 of the body 1 includes a stopping device that can act at a front end of the positioning rod 6 to stop the depressed pressing bar 3 from rebounding. It is enough to use fingers except for thumb to operate the stopping device when gripping the handle 11 of the body 1 with single hand.

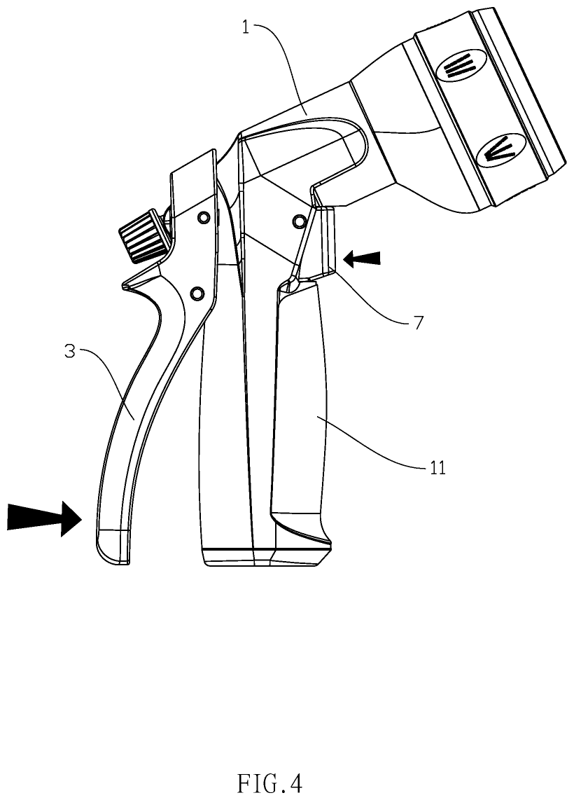

As shown in FIG. 1-5, a front side of the handle 11 includes a recess 12. The stopping device includes a button 7, arranged in the recess 12 and rotatably connected with the body 1, capable of rotating within a certain range of angle. A groove 13 is disposed in the body 1 and communicates with the recess 12. The positioning rod 6 is moved along the groove 13 to insert into the recess 12. The button 7 is provided with a stop column 71 that is misaligned with the positioning rod 6. As shown in FIG. 4, the upper end of the pressing bar 3 swings backward to make the positioning rod 6 move backward. The stop column 71 is moved to a position in front of the positioning rod 6 after the pressing bar 3 is depressed. After releasing the pressing bar 3, the pressing bar 3, by the first compression spring 5, rebounds to make the positioning rod 6 move forward. Then the positioning rod 6 is stopped by the stop column 71, stopping the pressing bar 3 move back to its original position. In order for the button 7 being positioned automatically during ejecting water, the button 7 is matched in the recess 12 and is held as a result of the positioning rod 6 abutting against the stop column 71.

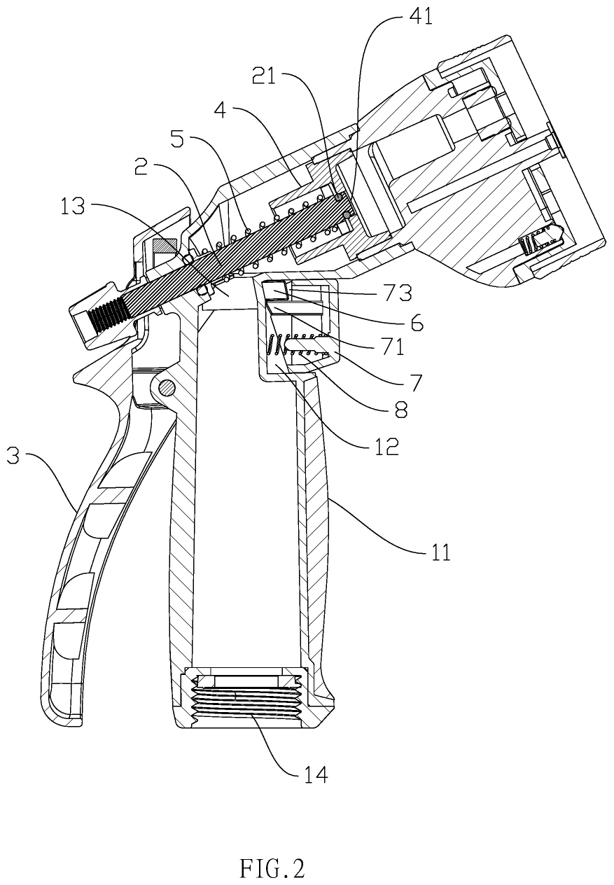

As shown in FIG. 2-5, an upper portion of the button 7 is hinged on two side walls of the recess 12. The stop column 71 locates under the positioning rod 6. In a case that the positioning rod 6 exits the recess 12, the button 7 is rotated clockwise by pressing upon a lower portion of the button 7 to raise the stop column 71 for moving to the position in front of the positioning rod 6. The positioning rod 6 abuts against the stop column 71 and provides a clockwise torque that is performed by the first compression spring 5 after releasing the pressing bar 3. The button 7 is provided with an inclined wall 72 capable of abutting against a bottom surface of the recess 12 to limit the button 7 from rotating when the stop column 71 is moved to the position in front of the positioning rod 6. The button 7 is fixed by the cooperation of a clockwise torque given by the positioning rod 6 and a counterclockwise torque given by the bottom surface of the recess 12. It is a simple structure.

As shown in FIG. 1-5, in order for the button 7 moving back to its original position after the positioning rod 6 leaves the stop column 71, a second compression spring 8 is disposed between the lower portion of the button 7 and the body 1. The second compression spring 8 pushes the lower portion of the button 7 forward to provide a counterclockwise torque.

As shown in FIG. 1-5, in order for the button 7 not being moved until the pressing bar 3 is depressed, a slot 73 is disposed in a position above the stop column 71 on the button 7. The slot 73 is capable of being inserted with the positioning rod 6 to limit the button 7 from rotating.

Each of the groove 13 and the recess 12 is isolated from the inner channel of the body 1 for water tightness.

Preferably, the rear end of the positioning rod 6 is rotatably connected with the upper end of the pressing bar 3.

Preferably, a water inlet 14 is disposed at a bottom end of the handle 11, and a water outlet is disposed at an anterior of the body 1.

As shown in FIG. 4, when in use, press the pressing bar 3 to make the positioning rod 6 exit the slot 73, and then press the button 7 with forefinger to make the stop column 71 move to the front of the positioning rod 6. After releasing the pressing bar 3, the pressing bar 3 rebounds slightly so that the positioning rod 6 moves back to abut against the stop column 71. Therefore, the pressing bar 3 is fixed after releasing the button 7, and water is ejected. When to stop water, press the pressing bar 3 to move the positioning rod 6 backward for leaving the stop column 71, and then the button 7 rebounds automatically through the second compression spring 8 so that the sealing portion 21 seals the through hole 41 to stop water. In the meanwhile, the positioning rod 6 inserts into the slot 73 to relock the button 7. It is simple and convenient to operate so as to save labor for a long time use.

Although particular embodiments of the present invention have been described in detail for purposes of illustration, various modifications and enhancements may be made without departing from the spirit and scope of the present invention. Accordingly, the present invention is not to be limited except as by the appended claims.

1. A spray nozzle with posterior positioned switch, characterized in comprising a body, a shaft and a pressing bar, the body including a plug blocking off an inner channel disposed in the body, the plug being provided with a through hole in communication with the inner channel, a middle portion of the pressing bar being hinged on a posterior of the body, a rear end of the shaft extending outside the body and being connected to an upper end of the pressing bar, a front end of the shaft being provided with a sealing portion capable of blocking off the through hole, the body being provided with a first compression spring to push the shaft forward for the sealing portion blocking off the through hole, a positioning mechanism being disposed between the body and the pressing bar, the positioning mechanism being controlled by fingers except for thumb to stop the depressed pressing bar in a case that a handle of the body is held in hand.

2. The spray nozzle with posterior positioned switch as claimed in claim 1, wherein the positioning mechanism includes a positioning rod capable of moving back and forth on the body, a rear end of the positioning rod being connected with the upper end of the pressing bar to be moved back and forth along with a swinging motion of the pressing bar; the handle of the body includes a stopping device that can act at a front end of the positioning rod to stop the depressed pressing bar from rebounding.

3. The spray nozzle with posterior positioned switch as claimed in claim 2, wherein a front side of the handle includes a recess; the stopping device includes a button, arranged in the recess and rotatably connected with the body, capable of rotating within a certain range of angle; a groove is disposed in the body and communicates with the recess, the positioning rod being moved along the groove to insert into the recess; the button is provided with a stop column that is misaligned with the positioning rod, the stop column being moved to a position in front of the positioning rod after the pressing bar is depressed, so that the positioning rod abuts against the stop column and is stopped from moving forward, the button being matched in the recess and being held as a result of the positioning rod abutting against the stop column.

4. The spray nozzle with posterior positioned switch as claimed in claim 3, wherein an upper portion of the button is hinged on two side walls of the recess; the stop column locates under the positioning rod; in a case that the positioning rod exits the recess, the button is rotated clockwise by pressing upon a lower portion of the button to raise the stop column for moving to the position in front of the positioning rod, the positioning rod abutting against the stop column and providing a clockwise torque that is performed by the first compression spring after releasing the pressing bar; the button is provided with an inclined wall capable of abutting against a bottom surface of the recess to limit the button from rotating when the stop column is moved to the position in front of the positioning rod.

5. The spray nozzle with posterior positioned switch as claimed in claim 4, wherein a second compression spring is disposed between the lower portion of the button and the body, the second compression spring pushing the lower portion of the button forward to provide a counterclockwise torque.

6. The spray nozzle with posterior positioned switch as claimed in claim 4, wherein a slot is disposed in a position above the stop column on the button, the slot capable of being inserted with the positioning rod to limit the button from rotating.

7. The spray nozzle with posterior positioned switch as claimed in claim 3, wherein each of the groove and the recess is isolated from the inner channel of the body.

8. The spray nozzle with posterior positioned switch as claimed in claim 2, wherein the rear end of the positioning rod is rotatably connected with the upper end of the pressing bar.

9. The spray nozzle with posterior positioned switch as claimed in claim 1, wherein a water inlet is disposed at a bottom end of the handle, and a water outlet is disposed at an anterior of the body.
